(19) United States
(12) Patent Application Publication
(10) Pub. No.: US 2002/0035598 A1
(43) Pub. Date: Mar. 21, 2002

(54) Communication system, transmitter, receiver, and method utilizing a data storage descriptor

(76) Inventor: Laurent Herrmann, Le Kremlin-Bicetre (FR)

Correspondence Address: Corporate Patent Counsel, U.S. Philips Corporation, 580 White Plains Road, Tarrytown, NY, 10591, US

(21) Appl. No.: 09/935,259

(22) Filed: Aug. 22, 2001

(30) Foreign Application Priority Data
Aug. 22, 2000 (FR) 0010802

(51) Int. Cl. G06F 15/16

(52) U.S. Cl. 709/203; 709/219

(57) ABSTRACT

The invention relates to a communication system between a transmitter and a receiver, which transmitter transmits digital data via a communication channel to the receiver. Such a communication system provides an identification of the data which are capable of a multiple-use at the level of the transmitter by means of data descriptors inserted in the data flow sent from the transmitter to the receiver. The data flow received at the receiver end is then analyzed so as to detect the presence of data descriptors indicating the presence of multiple-use data. Whenever such a descriptor is detected, it is locally stored at the level of the receiver together with the data to which it relates. The multiple-use data thus stored may then be used not only immediately after their reception at the receiver end, but also subsequently without the necessity of requesting them from the transmitter.

The invention relates to a communication system between a transmitter and a receiver, which transmitter transmits digital data and data descriptors to the receiver via a communication channel.

It has numerous applications in communication systems for multimedia data in which a point-to-point architecture is implemented, or more generally a client/server architecture.

The PCT document published under no. WO 98/03016 describes a method and a system for sending digital data from a transmitter to a receiver over a unidirectional communication channel. The receiver receives digital data which are collected and locally stored on the basis of criteria reflecting a user profile, such that the data thus stored can subsequently be used by the user at the receiver end.

The storage method for the data sent by the transmitter as used in the prior-art document has a certain number of limitations.

First of all, the selection of the data stored at the receiver end renders necessary the use of a user profile at the receiver end which permits of retaining only those data which correspond to the various criteria contained in said profile. If the receiver is used by different users, it is necessary a priori to have available as many profiles as there are users, which on the one hand means that sufficient memory space must be available for storing the profiles, and on the other hand requires means for readily changing over to another user profile. This selection method, which is not very flexible in use, accordingly implies the use of expensive means.

Secondly, the use of a user profile for selecting the data has limitations. In fact, a user profile never contains a full representation of the preferences of a user but instead contains general preferences, so that it is not improbable that certain data received at the receiver end and corresponding to preferences of the user are not selected for storage, because they have not been included in the user profile. In that case a data not stored locally but of interest to the user, such that he/she wants to consult it, will have to be sent by the transmitter, which involves a risk of saturating the communication channel and of not having the data immediately available.

The invention has for its object to counteract these limitations to a high degree by proposing a communication system, a receiver, as well as a method which have the object of associating descriptors with data sent by the transmitter so as to identify at the receiver end in a manner more reliable and less expensive than that described in the prior-art document those data which are to be stocked and which are capable of a multiple use.

This invention may advantageously be used if data to be sent by the transmitter correspond to data of text type, audio type (e.g. coded according to the MPEG-2 or MPE3 audio standards), or video type (e.g. coded according to the MPEG-2, MPEG-4 or H.263 video standards).

To achieve this object, the present invention is characterized in that the transmitter comprises:

analysis means for analyzing digital data so as to identify data referred to as multiple-use data which can be used several times at the receiver end, and data referred to as single-use data which can be used only once upon reception at the receiver end,

creation means for creating data descriptors for describing each multiple-use data previously identified, said descriptors comprising a set of characterizing fields, and

insertion means for inserting the data descriptors in the set of multiple-use data, each multiple-use data being then associated with a data descriptor.

The invention is also characterized in that the receiver comprises:

analysis means for analyzing received data so as to detect the presence of descriptors of multiple-use data and thus to identify multiple-use data and single-use data,

storage means for storing detected multiple-use data and their associated descriptors previously received,

composition means for composing the contents of an application on the basis of single-use data and multiple-use data previously stored, a same data which has a multiple use in the composition of said contents being then directly recovered upon each use from said storage means by recovery means.

Such a communication system, in contrast to the system described in the prior-art document, in which the selection of the data capable of a multiple use is made at the receiver level, provides an identification of the multiple-use data at the transmitter end by means of data descriptors inserted into the data flow sent by the transmitter to the receiver. The data flow, received at the receiver end is then analyzed so as to detect the presence of data descriptors which indicate the presence of multiple-use data. Whenever such a descriptor is detected, it is locally stored at the receiver end together with the data to which it relates. The multiple-use data thus stored may be used from that moment on not only immediately following their reception at the receiver end, but also later without the necessity of requesting for them to be sent from the transmitter.

According to a further characteristic of the invention, the descriptors and the corresponding data, both stored locally, are permanently made available so as to take into account not only the current processing capacities of the receiver but also various temporal parameters characteristic of each stored multiple-use data.

These as well as other, more detailed aspects of the invention will be clarified further in the following description with reference to the annexed drawings, all by way of example to which the invention is not limited, wherein:

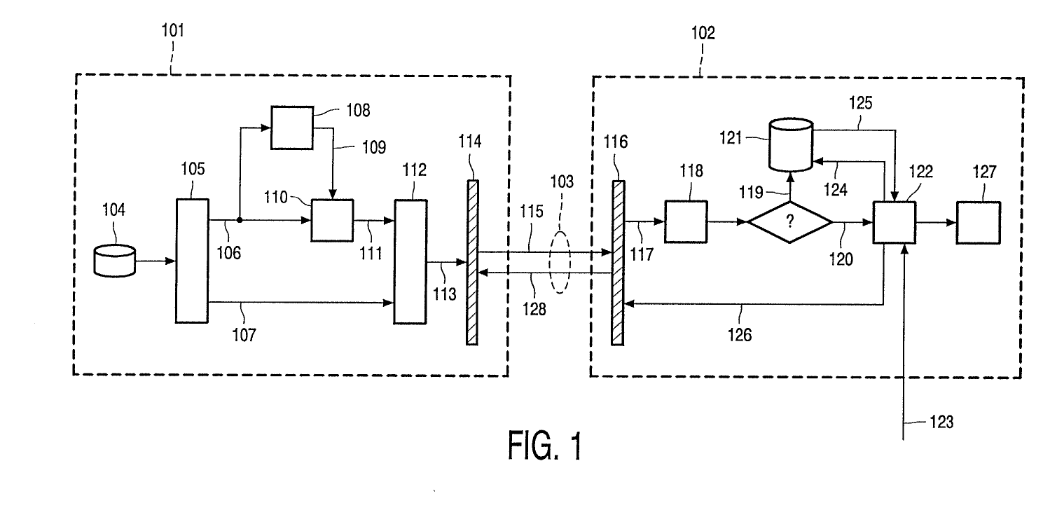

FIG. 1 is a block diagram of an example of a communication system comprising a transmitter and a receiver according to the invention,

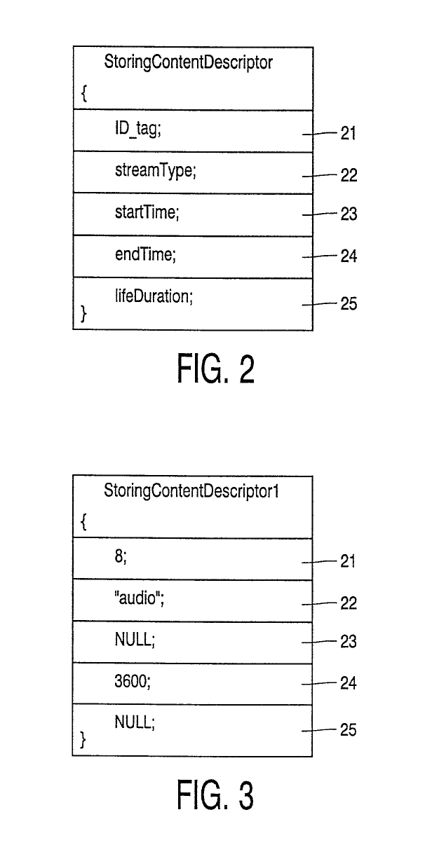

FIG. 2 shows the structure of the descriptors of the data according to the invention,

FIG. 3 shows the structure of a first data descriptor according to the invention by way of example,

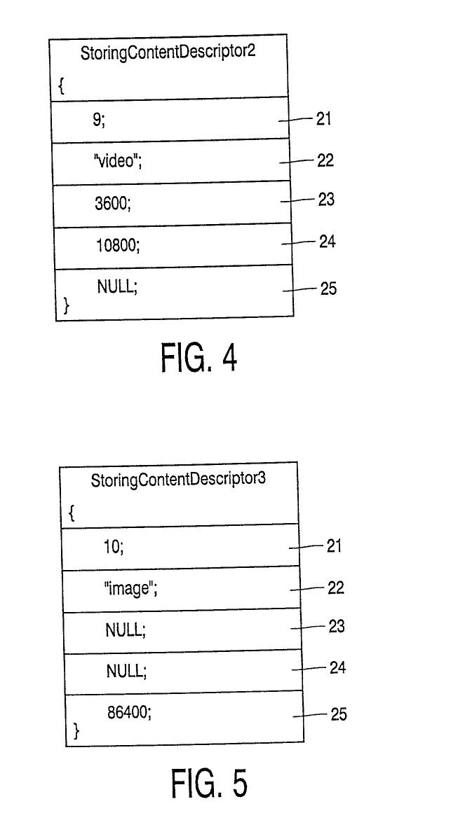

FIG. 4 shows the structure of a second data descriptor according to the invention by way of example,

FIG. 5 shows the structure of a third data descriptor according to the invention by way of example,

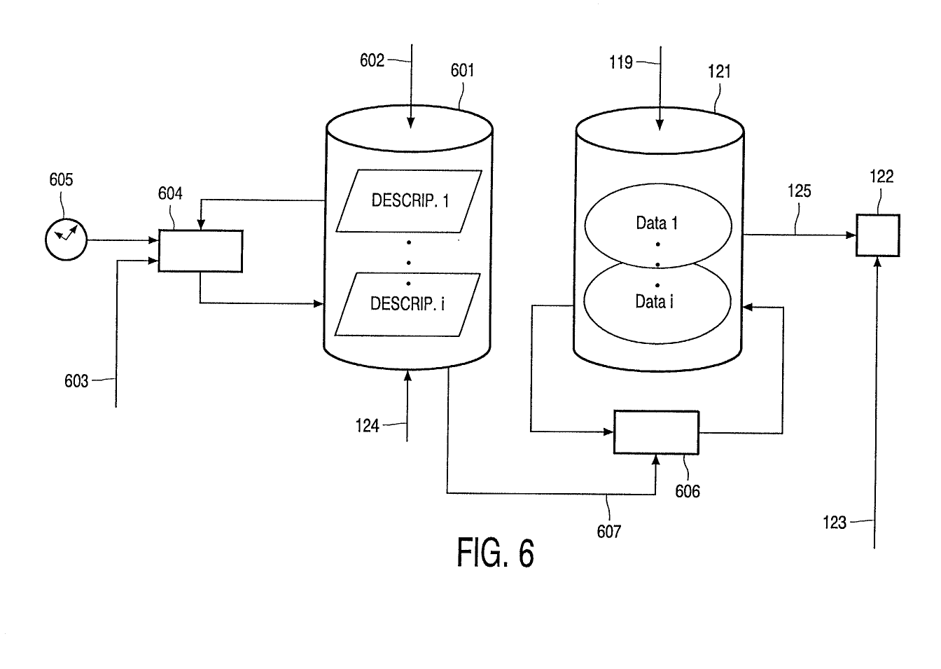

FIG. 6 is a diagram showing the operation of a receiver according to the invention in detail, and

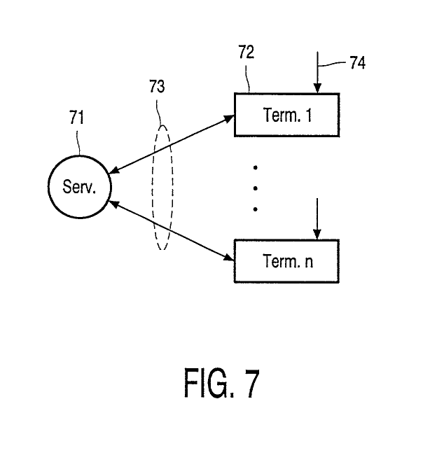

FIG. 7 shows a communication system according to the invention between a server and a number of terminals.

FIG. 1 represents a communication system according to the invention comprising a transmitter 101 and a receiver 102 which are in communication via a communication channel 103.

The transmitter comprises:

a data source 104 which generates various data such as data of the audio, video, text, or image type.

analysis means 105 for analyzing each of the data 104 and classifying them into two categories, on the one hand the multiple-use data 106 capable of a multiple utilization at the receiver end 102, and on the other hand the single-use data 107 which will basically be used once only at the receiver end. Multiple-use data are detected, for example, after an a-priory selection depending on the type of said multiple-use data, or other identification parameters. This classification may be implemented, for example, by anticipating the requests of a user present at the receiver end 102. For example, if the data 104 relate to video trailers of TV programs, it is highly probable that these data will be used several times at the receiver end, for which reason they are classified as data 106. On the other hand, if the data 104 relate to a very specific content which is not likely to be used several times at the receiver end, they will be classified among the data 107.

creation means 108 for creating data descriptors for multiple-use data. The functional block 108 creates a data descriptor with multiple fields 109 for each of the multiple-use data 106, each field being characteristic of the data under consideration. The descriptor acts not only as an identifier for the multiple-use data, but also characterizes them, especially with a view to facilitating their handling and control at the receiver end.

insertion means 110 for inserting each descriptor 109 in the data flow 106. Each multiple-use data 106 is thus associated with its descriptor 109, for example through concatenation of the data 106 with the data 109. The new data flux 111 thus generated at the output of the insertion means 110 is accordingly formed by a sequence of multiple-use data/descriptor data twins.

a multiplexing unit 112 for the data 111 and 107, which are multiplexed so as to deliver the data flow 113, which then comprises a succession of single-use data and data twins of descriptors and multiple-use data. This multiplexing may be, for example, compliant with the MPEG-2 Transport Stream standard.

a transport layer 114 for interfacing the transmitter with the communication channel 103 and for delivering a data flow 115 sent to the receiver 102 via the communication channel 103 on the basis of the multiplexed data 113.

The receiver 102 comprises:

a transport layer 116 which receives the data flow 115 and generates the data flow 117,

analysis means 118 for detecting the multiple-use data 119 and the single-use data 120 in the data flow 117. For this purpose, the data descriptors 109 which were strung together with the multiple-use data at the transmitter end are detected: if such a descriptor present in the data flow 117 is effectively detected by the analysis means 118, this will reveal the presence of a multiple-use data to which it is attached. If no data descriptor is detected, all data contained in the data flow 117 are classified as single-use data.

storage means 121 for storing multiple-use data and their associated descriptors. For example, the data descriptor/multiple-use data twins may be stored on a disc or in a memory. It may also be envisaged to store separately multiple-use data on a first storage means, and the corresponding data descriptors on a second storage means.

composition means 122 for composing a content for an application on the basis of stored multiple-use data 119 and single-use data 120. For example, the composition means may correspond to a navigator for multimedia data by means of which a user has a possibility of interacting via the access 123 so as to modify the contents of the application and to call up specific data in which he or she has an interest. A search is carried out via the access 124 among all the multiple-use data previously stored for each request 123 indicating a user's wish to consult a particular data, so as to verify whether this particular data has not yet been previously stored. If it appears that this data has been previously stored, it is sent directly to the composition unit 122 via the path 125 for taking part in the composition of a novel content without the necessity of having it sent from the transmitter. If this particular data is not present among the data stored in 121 and the communication channel 103 comprises a return path 128 between the receiver 102 and the transmitter 101, a request 126 will be sent via the transport layer 116 to the transmitter, then via said return path 128 towards the transmitter 101, the latter then sending to the receiver the missing data via the path 115 so that this data can be used in the composition of the content. If the particular data is not present among the data stored in 121 and the communication channel 103 does not comprise a return path 128, the user's demand cannot be satisfied. Whenever a new content relating to single-use data is created, these are used directly upon their detection in the data flow 117, and no storage space is reserved for them, in contrast to the multiple-use data, which are immediately stored in 121 and then used in the composition of the content. Since the multiple-use data are systematically stored, they are readily available from then on at any moment if the composition unit 122 needs them for the creation of a new content. This renders it possible not only to refrain from demanding data from the transmitter 101, which could overburden the communication channel 103, but also to improve the availability of the data at the level of the receiver by giving the latter a high degree of operational autonomy. To avoid the storage of multiple-use data which are not useful and take up space, the invention provides means for making these data apparent, which means will be explained with reference to FIG. 3.

visualization means 127 for making a content of multimedia data visible, such as a video screen which enables a user to see and interact with a content composed by the navigator 122.

FIG. 2 shows the structure of the data descriptors according to the invention. These descriptors, as was noted above, are inserted at the transmitter level for each so-called multiple-use data which may be used several times at the receiver end. These descriptors serve on the one hand to identify the multiple-use data received by the receiver so that it will store them locally, and on the other hand to inform the receiver of the characteristics of these multiple-use data by means of various fields so that the receiver can carry out operations for making the stored multiple-use data visible.

The structure of the data descriptor according to the invention, given by way of example here, comprises five fields:

the field 21 corresponds to an identifier, for example a digital one, which renders it possible to differentiate the descriptors from one another and thus to avoid any confusion,

the field 22 gives information on the type of data to which the descriptor belongs. For example, the field may indicate to the receiver that data of the audio, video, or image type are concerned. If the receiver is not capable of processing a certain type of information, for example if the video format cannot be decoded owing to the absence of suitable processing means, this information provided by the field 22 will prove useful because the corresponding data will not be stored so as not to occupy storage space of the receiver unnecessarily.

the field 23 is a time value given in relation to a time reference such as a local clock situated at the receiver end. This value is a starting time indicating to the receiver from what moment the data to which the descriptor is attached can be used. Let us assume that multiple-use data corresponding, for example, to trailers of video films programmed for an entire week have been stored on the receiver, and a user can consult these data by means of an electronic program guide (EPG). If the EPG can only present the video data of the present day, for example because of equipment limitations, only those video data will be made active and accordingly capable of consultation whose associated descriptor fields 23 have a date corresponding to the current date. If this is not the case, the data for which the field 23 of the associated descriptor is a date corresponding to subsequent days will not be made active. In concrete terms, a video data will be rendered active in that it is decoded in such a manner that it is quickly accessible and usable whenever the user wants to consult it.

the field 24 is a time value given in relation to a time reference such as a local clock situated at the receiver end. This value is an end date indicating to the receiver from what moment the data to which the descriptor is attached will no longer have to be stored by the receiver. Taking the example of the multiple-use data corresponding to film trailers again, the field 24 of each descriptor will correspond to the end date of the film to which it is attached. In other words, the field 24 corresponds to the end date of the validity of the data to which it is attached.

the field 25 is a time value corresponding to the maximum duration for storage of the data on the receiver. This field renders possible a data management in a time different to that controlled by the fields 23 and 24. This field 25 applies more particularly to multiple-use data which do not have an absolute time reference. Starting from the moment the multiple-use data is received at the receiver, the storage duration is calculated and compared with that of the field 25 so as to comply with the maximum duration of storage.

FIGS. 3, 4, and 5 give examples of descriptors according to the invention for which the various fields have been completed.

FIG. 3 shows the structure of a descriptor relating to an audio-type data. This descriptor according to the invention is identified by the digit 8 and relates to a data valid up to the date 3600, which absolute date is expressed in the time unit current for the receiver and in relation to a time reference of this same receiver.

FIG. 4 shows the structure of a descriptor relating to a video-type data. This descriptor according to the invention is identified by the digit 9 and relates to a data valid between the dates 3600 and 10,800, which absolute dates are expressed in the time unit current for the receiver and in relation to a time reference of this same receiver.

FIG. 5 shows the structure of a descriptor relating to an image-type data. This descriptor according to the invention is identified by the number 10 and relates to a data valid for a duration of 86,400, starting from its reception by the receiver, which absolute time is expressed in the time unit current for the receiver and in relation to a time reference of this same receiver.

FIG. 6 is a diagram representing the operation of a receiver according to the invention as described with reference to FIG. 1 in detail. This diagram relates more particularly to the system for making available the multiple-use data and their associated descriptors stored locally for subsequent use. As was noted above, the data accompanied by a data descriptor whose structure is similar to that of FIG. 1 are added to the data referred to as multiple-use data which can be used several times by a user at the receiver end. These multiple-use data 119 are locally stored in the receiver in a storage unit 121, and similarly their associated descriptors 602 are stored in the storage unit 601.

Immediately after their initial storage in the unit 601 the descriptors are analyzed by way of their various fields so as to verify that the data to which they belong are compatible with the capacities 603 of the receiver and that these data can be effectively used at the receiver end. For example, capacities 603 of the receiver may be stored locally in a storage means on said receptor. For this purpose, the means 604 for making the data available check and verify the compatibility of the fields 22 of each descriptor with the capacities 603 of the receiver. For example, if the receiver cannot process video-type data, the data 119 and their associated descriptor 602 of the video type will not be stored, or will be temporally stored and immediately erased from the units 601 and 121.

After the compatibility of the multiple-use data with the processing capacity of the receiver has been verified, the data 119 are periodically updated by the means 604. This updating has for its object in particular to erase the data 119 which are judged to be useless, or to render them active so that they can be quickly available and readily usable for the creation, for example, of a multimedia content. For this purpose, the time fields 23, 24, and 25 of the descriptors 602 are periodically compared with a local clock 605 belonging to the receiver for ensuring that the validity end date corresponding to the field 24 has not been reached, or that the validity duration corresponding to the fields 25 has not elapsed, which in the opposite case would have the result that the corresponding descriptors and their attached data are erased. Similarly, the validity start date corresponding to the field 23 is periodically compared with the clock 605 so as to prepare the data which are about to be used. For this purpose, preparation means 606 are provided for enabling a preparation of the stored data 119, which preparation means are controlled by decision commands 607 generated following a comparison between the field 23 and the clock 605. For example, if a multiple-use data 119 corresponds to a compressed video which can be consulted starting from a moment of validity t1, a preparation command 607 will be generated some time before this moment t1 such that this video data can be decompressed by the preparation device 606, whereupon the decompressed video will replace the compressed video in the storage unit 121. If a user interacting via the request 123 with the contents of the application created at the composition unit level 122 wishes to consult a particular data, and if this data is recognized as being a data already stored locally, the command 124 is given to deliver this data over the path 125 to the contents composition unit 122. If this is a video-type data, it is thus interesting that it should be quickly available, i.e. decompressed.

If a user wishes to consult a particular data, all means may be activated for determining whether this data corresponds to a locally stored data or not. It is in fact possible that a user requires access to a multiple-use data erased from the storage units 601 and 121. Generally speaking, it will suffice to search in the set of descriptors 602 whether a descriptor identical to that of the desired data exists. If this is the case, the data is extracted from the storage unit, if it is not, the user request is not honored. For example, comparison means may be used to compare the descriptor of a particular data with the overall set of data descriptors previously stored on the receiver, for deducing whether said particular can be retrieved.

This FIG. 6 only shows the processing of multiple-use data, the single-use data being processed in a conventional manner as they arrive at the receiver as a function of its processing capacity.

FIG. 7 shows an example of a communication system according to the invention. This communication system corresponds, for example, to a system used in a broadcast context between a server (i.e. transmitter) and a set of clients (i.e. receivers).The system is composed of a server 71 which communicates with n terminals 72 via a set of n communication channels 73. The server performs the part of a transmitter as described above, sending single-use data and multiple-use data accompanied by their data descriptors. In a so-called distributed application, the same data are sent to the set of terminals 72. These terminals act as receivers as described above, locally storing each and every multiple-use data identified as such in the data flow transmitted through the channels 73. Since each terminal is capable of receiving requests for data from a user via the access 74, the requests relating to multiple-use data stored locally are honored in that the corresponding data are delivered from the storage unit situated at the terminal in question.

A communication system between a transmitter and a receiver capable of identifying and storing at the receiver end those data which can be used several times by an application has thus been described. Numerous modifications may indeed be applied to the embodiments described without departing from the scope of the invention. It may in particular be envisaged to use a user profile in conjunction with the data retrieval means situated at the receiver such that only certain multiple-use data are retained. Moreover, additional fields may be added to the data descriptors of the multiple-use data so as to characterize more precisely those data to which they are attached. In particular, descriptors as described according to the invention may advantageously be used in a standard dedicated to data description, such as the MPEG-7 standard.

As regards the constructional implementation of such a communication system, use will be made of signal processors both at the transmitter end and at the receiver end, said processors carrying out the various operations described above on the digital data flows by carrying out instructions stored in a memory.

1. A communication system between a transmitter and a receiver, which transmitter transmits digital data and data descriptors to the receiver via a communication channel, which communication system is characterized in that the transmitter comprises:
a) analysis means for analyzing digital data so as to identify data referred to as multiple-use data which can be used several times at the receiver end, and data referred to as single-use data which can be used only once upon reception at the receiver end,
b) creation means for creating data descriptors for describing each multiple-use data previously identified, said descriptors comprising a set of characterizing fields, and
c) insertion means for inserting the data descriptors in the set of multiple-use data, each multiple-use data being then associated with a data descriptor, and in that the receiver comprises:
d) analysis means for analyzing received data so as to detect the presence of descriptors of multiple-use data and thus to identify multiple-use data and single-use data,
e) storage means for storing detected multiple-use data and their associated descriptors previously received,
f) composition means for composing the contents of an application on the basis of single-use data and multiple-use data previously stored, a same data which has a multiple use in the composition of said contents being then directly recovered upon each use from said storage means by recovery means.

2. A communication system as claimed in claim 1, characterized in that the receiver comprises means for updating descriptors and multiple-use data previously received and stored in said storage means, said updating means taking into account in particular a capacity of the receiver to deal with the contents of the multiple-use data to which said descriptors are attached and various time parameters contained in each descriptor in relation to a local clock.

3. A communication system as claimed in claim 1, characterized in that each descriptor of multiple-use data comprises a set of fields corresponding in particular to an identification code which renders it possible to distinguish the descriptor from the other descriptors, to the type of data to which the descriptor is attached, to a starting date and a final date defining a time window in which the data associated with the descriptor can be used, and to a duration of use for the data associated with the descriptor.

4. A receiver for receiving digital data, characterized in that it comprises:
a) analysis means for analyzing received data so as to detect the presence of descriptors of multiple-use data and thus to identify multiple-use data and single-use data,
b) storage means for storing detected multiple-use data and their associated descriptors previously received,
c) composition means for composing the contents of an application on the basis of single-use data and multiple-use data previously stored, a same data which has a multiple use in the composition of said contents being then directly recovered upon each use from said storage means by recovery means.

5. A receiver as claimed in claim 4, characterized in that it comprises updating means for updating descriptors and multiple-use data previously received and stored in said storage means, said updating means taking into account in particular a capacity of the receiver to deal with the contents of the multiple-use data to which said descriptors are attached and various time parameters contained in each descriptor in relation to a local clock.

6. A transmitter for transmitting digital data and data descriptors over a communication channel, characterized in that it comprises:
a) analysis means for analyzing digital data so as to identify data referred to as multiple-use data which can be used several times at the receiver end, and data referred to as single-use data which can be used only once upon reception at the receiver end,
b) creation means for creating data descriptors for describing each multiple-use data previously identified, said descriptors comprising a set of characterizing fields, and
c) insertion means for inserting the data descriptors in the set of multiple-use data, each multiple-use data being then associated with a data descriptor

7. A signal composed of digital data associated with descriptors, which signal is characterized in that each descriptor of multiple-use data comprises a set of fields corresponding in particular to an identification code which renders it possible to distinguish the descriptor from the other descriptors, to the type of data to which the descriptor is attached, to a starting date and a final date defining a time window in which the data associated with the descriptor can be used, and to a duration of use for the data associated with the descriptor.

8. A method of describing and recognizing data sent from a transmitter to a receiver via a communication channel, which transmitter transmits digital data and data descriptors to the receiver, which method is characterized in that the transmission of the data comprises:
a) an analysis step for analyzing digital data so as to identify data referred to as multiple-use data which can be used several times at the receiver end, and data referred to as single-use data which can be used only once upon reception at the receiver end,
b) a creation step for creating data descriptors for describing each multiple-use data previously identified, said descriptors comprising a set of characterizing fields, and
c) an insertion step for inserting the data descriptors in the set of multiple-use data, each multiple-use data being then associated with a data descriptor, and in that the reception of the data comprises:
d) an analysis step for analyzing received data so as to detect the presence of descriptors of multiple-use data and thus to identify multiple-use data and single-use data,
e) a storage step for storing detected multiple-use data and their associated descriptors previously received,
f) a composition step for composing the contents of an application on the basis of single-use data and multiple-use data previously stored, a same data which has a multiple use in the composition of said contents being then directly recovered upon each use from said storage means by recovery means.

9. A communication system as claimed in claim 1 between a server acting as the transmitter and a terminal acting as the receiver for transmitting digital encoded data in accordance with the MPEG-4 standard.

10. A computer support program for a communication terminal, said computer program comprising a series of instructions which, when they are loaded into the communication terminal, enable said communication terminal to execute the method of recognizing multiple-use data as claimed in claim 8.
